(19) United States
(12) Patent Application Publication
(10) Pub. No.: US 2026/0131297 A1
(43) Pub. Date: May 14, 2026

(54) HYDROGEN GENERATOR INCLUDING A HEAT PIPE LINER

(71) Applicants: HYUNDAI MOTOR COMPANY, Seoul (KR); KIA CORPORATION, Seoul (KR); Pukyong National University Industry-University Cooperation Foundation, Busan (KR)

(72) Inventors: Kyung Soo Park, Hwaseong-si (KR); Ha Eun Jeong, Hwaseong-si (KR); Pyung Soon Kim, Hwaseong-si (KR); Junghun Shin, Hwaseong-si (KR); Wukchul Joung, Busan (KR); Bomi Nam, Busan (KR)

(73) Assignees: HYUNDAI MOTOR COMPANY, Seoul (KR); KIA CORPORATION, Seoul (KR); Pukyong National University Industry-University Cooperation Foundation, Busan (KR)

(21) Appl. No.: 19/264,589

(22) Filed: Jul. 9, 2025

(30) Foreign Application Priority Data
Nov. 8, 2024 (KR) 10-2024-0158134

(51) Int. Cl. B01J 8/06; C01B 3/38

(52) U.S. Cl. CPC B01J 8/067; C01B 3/38; B01J 2208/00168; C01B 2203/0211; C01B 2203/0833; C01B 2203/1011

(57) ABSTRACT

A hydrogen generator includes a reforming reactor configured to produce hydrogen by a catalytic reaction of a reactant; and a heat pipe liner configured to maintain the temperature of the reforming reactor and provided inside the reforming reactor. The heat pipe liner includes an external tube with a hollow interior; an internal tube provided inside the external tube where an internal space is formed between the external tube and the internal tube; an upper plate covering the upper part of the internal space; and a lower plate covering the lower part of the internal space. A catalyst bed is provided that produces products through a chemical reaction with the reactant inside the internal tube, and a porous metal layer is formed in the internal space, where a working fluid circulating through the pores of the porous metal layer is provided.

### CROSS-REFERENCE TO RELATED APPLICATION

This application claims priority to and the benefit of Korean Patent Application No. 10-2024-0158134, filed with the Korean Intellectual Property Office on Nov. 8, 2024, the entire contents of which are incorporated herein by reference.

### FIELD

The present disclosure relates to a hydrogen generator including a heat pipe liner, and more particularly, the present disclosure relates to a hydrogen generator including a heat pipe liner capable of uniformly maintaining a temperature of a reforming reactor.

### BACKGROUND

Due to the depletion of fossil energy and environmental pollution problems, renewable and alternative energy sources have gained significant attention, and hydrogen is emerging as one such promising alternative.

The fuel cell and the hydrogen combust device use hydrogen as a reaction gas, in order to apply the fuel cell and the hydrogen combust device to vehicles and various electronic products for example, a stable and continuous supply technology of hydrogen is required.

In order to obtain a stable supply of hydrogen gas (H2) that is an environmentally friendly fuel, it is essential to secure a high-efficiency reforming system.

Conventionally, in a reforming reactor that produces hydrogen gas by a reaction between a reactant (e.g., CH4, H2O, CO2) and a catalyst, in order to maintain a uniform temperature gradient generated inside the reactor by a catalytic reaction (e.g., an endothermic reaction), a method is used to maintain the temperature of the reactor uniform by installing a separate heating member and controlling the temperature of the heating member.

However, in order to control the temperature of the reactor using the separate heating member, there is a problem that it is difficult to achieve a certain level of the temperature uniformity due to the characteristics of the amount of heat.

The above information disclosed in this Background section is only for enhancement of understanding of the background of the disclosure and therefore it may contain information that does not form the prior art that is already known to those having ordinary skill in the art.

### SUMMARY

The present disclosure provides a hydrogen generator capable of maintaining the temperature uniformity of the reactor without using a separate heating member to keep the temperature gradient of the reactor constant and without individually controlling the amount of heat.

According to an embodiment of the present disclosure, a hydrogen generator includes: a reforming reactor configured to produce hydrogen by a catalytic reaction of a reactant; and a heat pipe liner configured to maintain the temperature of the reforming reactor uniformly and provided inside the reforming reactor. The heat pipe liner includes an external tube with a hollow interior; and an internal tube provided inside the external tube. An internal space is formed between the external tube and the internal tube. The heat pipe liner further includes: an upper plate covering the upper part of the internal space; a lower plate covering the lower part of the internal space; a catalyst bed where a chemical reaction with the reactant inside the internal tube occurs; and a porous metal layer formed in the internal space. A working fluid circulates through the pores of the porous metal layer.

In an embodiment of the present disclosure, the external tube and the internal tube may be formed into a cylinder shape with an empty interior, and the external tube and the internal tube may be arranged concentrically.

In an embodiment of the present disclosure, an injection port is formed in one of the upper plate and the lower plate, and a working fluid is injected into the internal space through the injection port. A degassing port is formed in one of the upper plate and the lower plate, and a residual gas in the internal space is discharged through the degassing port.

In an embodiment of the present disclosure, the injection port and the degassing port is implemented as separate ports, or integrated into a single port.

In an embodiment of the present disclosure, the porous metal layer may be formed by sintering and attaching a metal powder to a predetermined thickness on an inner surface of the external tube and an exterior surface of the internal tube.

In an embodiment of the present disclosure, the pores formed in the porous metal layer may be formed to be fluidly connected to each other.

In an embodiment of the present disclosure, the size of the pores formed in the porous metal layer may be formed to a predetermined size to generate a capillary pressure difference in the working fluid.

In an embodiment of the present disclosure, the working fluid may be an alkali metal.

In an embodiment of the present disclosure, the working fluid may be sodium, potassium, or a eutectic alloy of sodium and potassium.

In an embodiment of the present disclosure, the volume of the working fluid injected into the internal space may be greater than the volume of the pores of the porous metal layer by a predetermined amount.

According to an embodiment of the present disclosure, a hydrogen generator includes: a reforming reactor configured to produce hydrogen by a catalytic reaction of a reactant; and a heat pipe liner configured to maintain the temperature of the reforming reactor and provided inside the reforming reactor. The heat pipe liner includes an external tube with a hollow interior; an internal tube provided inside the external tube, wherein an internal space is formed between the external tube and the internal tube; an upper plate covering an upper part of the internal space; and a lower plate covering a lower part of the internal space. The heat pipe liner further includes: a catalyst layer where a chemical reaction with the reactant inside the reforming reactor occurs, and a porous metal layer may be formed in the internal space, where a working fluid circulates through the pores of the porous metal layer.

In an embodiment of the present disclosure, the external tube and the internal tube may be formed into a cylinder shape with an empty interior, and the external tube and the internal tube may be arranged concentrically.

In an embodiment of the present disclosure, an injection port may be formed in one of the upper plate and the lower plate, and a working fluid is injected into the internal space through the injection port. A degassing port may be formed in one of the upper plate and the lower plate, and a residual gas in the internal space is discharged through the degassing port.

In an embodiment of the present disclosure, the injection port and the degassing port may be implemented as separate ports, or integrated into a single port.

In an embodiment of the present disclosure, the porous metal layer may be formed by sintering and attaching a metal powder to a predetermined thickness on the inner surface of the external tube and the exterior surface of the internal tube.

In an embodiment of the present disclosure, the pores formed in the porous metal layer may be formed to be fluidly connected to each other.

In an embodiment of the present disclosure, the size of the pore formed in the porous metal layer may be formed to a predetermined size to generate a capillary pressure difference.

In an embodiment of the present disclosure, the working fluid may be an alkali metal.

In an embodiment of the present disclosure, the working fluid may be sodium, potassium, or a eutectic alloy of sodium and potassium.

In an embodiment of the present disclosure, the volume of working fluid injected into the internal space may be greater than the volume of the pores of the porous metal layer by a predetermined amount.

According to an embodiment of the present disclosure, when an imbalanced temperature field is formed in the reforming reactor by an endothermic reaction within the catalyst bed, a rapid thermal diffusion may occur from the high temperature part to the low temperature part of the reforming reactor due to the high-speed heat transfer function of the working fluid of the heat pipe liner, thereby improving the temperature uniformity of the reforming reactor.

Further, effects that can be obtained or expected from embodiments of the present disclosure are directly or suggestively described in the following detailed description. In other words, various effects expected from embodiments of the present disclosure are described in the following detailed description.

### BRIEF DESCRIPTION OF THE DRAWINGS

The drawings are provided for reference to explain an illustrative embodiment of the present disclosure, and the technical spirit of the present disclosure should not be interpreted to be limited to the accompanying drawings.

FIG. 1 is a conceptual view illustrating a side cross-section of a hydrogen generator according to an embodiment of the present disclosure.

FIG. 2 is a conceptual view of a planar cross-section of a hydrogen generator according to an embodiment of the present disclosure.

FIG. 3 is a perspective view illustrating a configuration of a heat pipe liner of a hydrogen generator according to an embodiment of the present disclosure.

FIG. 4 is a side view illustrating a configuration of a heat pipe liner of a hydrogen generator according to an embodiment of the present disclosure.

FIG. 5 is a cross-sectional view illustrating a configuration of a heat pipe liner of a hydrogen generator according to an embodiment of the present disclosure.

FIG. 6 is a top plan view illustrating a configuration of a heat pipe liner of a hydrogen generator according to an embodiment of the present disclosure.

FIG. 7 is a conceptual drawing illustrating a side cross-section of a hydrogen generator according to an embodiment of the present disclosure.

FIG. 8 is a view conceptually illustrating a planar cross-section of a hydrogen generator according to an embodiment of the present disclosure.

FIGS. 9-11 are views to explain an effect of a hydrogen generator according to an embodiment of the present disclosure.

It should be understood that the referenced drawings are not particularly illustrated according to a scale, present a brief expression of various features illustrating a basic principle of the present disclosure. For example, specific design features of the present disclosure, which include a specific dimension, a specific direction, a specific position, and a specific shape may be partially determined according to a specific intended application and a specific use environment.

### DETAILED DESCRIPTION

The terminology used herein is for the purpose of describing particular embodiments only, and is not intended to limit the present disclosure. As used herein, singular forms are intended to also include a plurality of forms, unless the context clearly indicates otherwise. It should be further understood that term “comprises” or “have” used in the present specification specify the presence of stated features, numerals, steps, operations, components, parts, or a combination thereof, but does not preclude the presence or addition of one or more other features, numerals, steps, operations, components, parts, or a combination thereof. Also, as used herein, the term “and/or” includes any plurality of combinations of items or any of a plurality of listed items.

The present disclosure is described more fully hereinafter with reference to the accompanying drawings, in which embodiments of the disclosure are shown. As those having ordinary skill in the art would realize, the described embodiments may be modified in various different ways, all without departing from the spirit or scope of the present disclosure.

In order to clearly explain the present disclosure, parts that are not related to the explanation may have been omitted. Like reference numerals designate like elements throughout the specification.

Further, since the sizes and thicknesses of constituent members shown in the accompanying drawings are arbitrarily given for better understanding and ease of description, the present disclosure is not limited to the illustrated sizes and thicknesses, and the thicknesses are shown enlarged to clearly express various parts and regions.

The terms “module” and “unit” for components used in the following description are used only in order to easily explain the specification. Therefore, these terms do not have meanings or roles that distinguish them from each other in themselves.

Further, in describing embodiments of the present specification, when it is determined that a detailed description of the well-known art associated with the present disclosure may obscure the gist of the present disclosure, it will be omitted.

In addition, the accompanying drawings are provided only to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like are used only to describe various components, and are not to be interpreted as limiting these components.

In the description, expressions described in the singular in this specification may be interpreted as the singular or plural unless an explicit expression such as “one” or “single” is used.

The terms are only used to differentiate one component from other components.

Hereinafter, a hydrogen generator according to an embodiment of the present disclosure is described in detail with reference to the attached drawings.

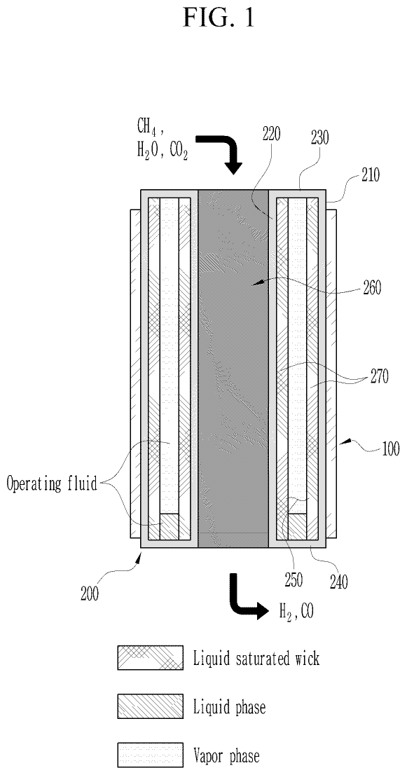

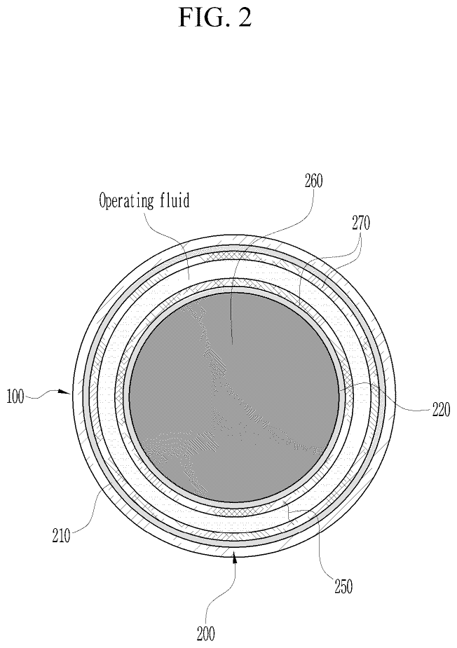

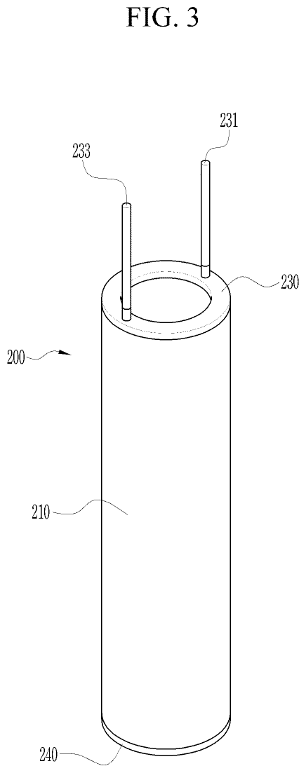

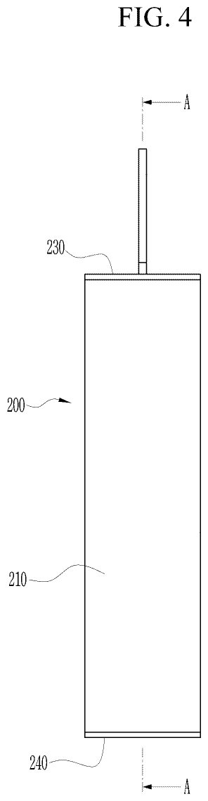

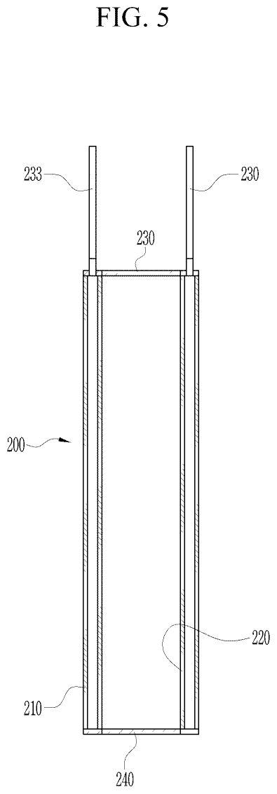

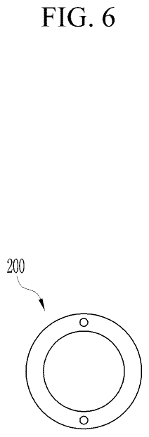

FIG. 1 is a conceptual view illustrating a side cross-section of a hydrogen generator according to an embodiment of the present disclosure. FIG. 2 is a conceptual view of a planar cross-section of a hydrogen generator according to an embodiment of the present disclosure. FIG. 3 is a perspective view illustrating a configuration of a heat pipe liner of a hydrogen generator according to an embodiment of the present disclosure. FIG. 4 is a side view illustrating a configuration of a heat pipe liner of a hydrogen generator according to an embodiment of the present disclosure. FIG. 5 is a cross-sectional view illustrating a configuration of a heat pipe liner of a hydrogen generator according to an embodiment of the present disclosure. FIG. 6 is a top plan view illustrating a configuration of a heat pipe liner of a hydrogen generator according to an embodiment of the present disclosure.

As shown in FIGS. 1-6, a hydrogen generator including a heat pipe according to an embodiment of the present disclosure may include a reforming reactor 100 and a heat pipe liner 200.

The reforming reactor 100 may produce a product including hydrogen through a chemical reaction (a catalytic reaction) with a reactant. The reforming reactor 100 may be formed into a cylinder shape with an empty interior. The reactants may include methane (CH4), water (H2O), and carbon dioxide (CO2), and the products may include hydrogen (H2), and carbon monoxide (CO).

The heat pipe liner 200 may maintain the temperature of the reforming reactor 100 to be uniform by the catalytic reaction in the reforming reactor 100, and the heat pipe liner 200 may be provided inside the reforming reactor 100. For example, the heat pipe liner 200 may be placed inside the reforming reactor 100, and the reforming reactor 100 may be placed surrounding the outside of the heat pipe liner 200.

The heat pipe liner 200 may include an external tube 210, an internal tube 220 provided inside the external tube 210, an upper plate 230 covering the upper portions of the external tube 210 and the internal tube 220, and a lower plate 240 covering the lower portions of the external tube 210 and the internal tube 220.

The external tube 210 may be formed into a cylinder shape with a hollow interior. The external tube 210 is formed of a metallic material, for example, a stainless steel or a refractory material such as Inconel.

The internal tube may be provided inside the external tube 210 and be formed into a cylinder shape with an empty interior. An internal space 250 may be formed between the internal tube 220 and the external tube 210. The internal tube 220 may be formed of a metallic material, for example, a stainless steel or a refractory material such as Inconel. The external tube 210 and the internal tube 220 may be arranged concentrically (or a coaxially). A catalyst bed 260 including a catalyst may be provided inside the internal tube 220.

The upper plate 230 may be formed in a ring shape of a circular plate with an opening in the approximate center, and cover the upper portion of the internal space 250 formed between the external tube 210 and the internal tube 220. The upper plate 230 is formed of a metallic material, for example, a stainless steel or a refractory material such as Inconel.

The lower plate 240 may be formed in a ring shape with an opening in the approximate center and cover the lower part of the internal space 250 formed between the external tube 210 and the internal tube 220. The lower plate 240 may be formed of a metallic material, for example, a stainless steel or a refractory material such as Inconel.

The internal space 250 formed between the external tube 210 and the internal tube 220 is covered by the upper plate 230 and the lower plate 240, so that the internal space 250 may be closed and sealed.

A porous metal layer 270 may be formed in the internal space 250 formed between the external tube 210 and the internal tube 220. For example, it may be formed by sintering and attaching a metal powder with a predetermined thickness on the inner surface of the external tube 210 and the exterior surface of the internal tube 220.

The porous metal layer 270 may be formed of a metallic material, for example, a stainless steel or a refractory material such as Inconel. The pores formed in the porous metal layer 270 may be formed to be fluidly connected to each other. The size of the pores formed in the porous metal layer 270 may be formed to a predetermined size (e.g., about several tens of μm) to generate a capillary pressure difference of the working fluid.

The closed and sealed internal space 250 may be equipped with the working fluid that controls the temperature of the reforming reactor 100 while flowing along the pores of the porous metal layer 270. The working fluid may be one of alkali metals, for example, sodium, potassium, or a eutectic alloy of sodium and potassium.

The working fluid may be determined according to the operation temperature of the reforming reactor 100. For example, in the reactor where the reforming reaction occurs at a high temperature of about 1,000 degrees Celsius or higher, sodium (Na) may be used as the working fluid.

The volume of the working fluid injected into the internal space 250 may be a predetermined amount (e.g., between 0 to 10%, between 0 to 5%) greater than the volume of the pores of the porous metal layer 270. By setting the volume of the working fluid injected into the internal space 250 to be a predetermined amount greater than the volume of the pores of the porous metal layer 270, the thermodynamic state within the internal space 250 of the heat pipe liner 200 may be maintained at a saturation.

Regarding the amount of the working fluid injected into the internal space 250 of the heat pipe liner 200, the volume (V_void) of the pores of the porous metal layer 270 be determined (V_void=(V_wick,ext)×φ) by multiplying the volume (V_wick,ext) of the outer shape of the porous metal layer 270 by the porosity (φ). The injection amount of the working fluid corresponding to the pores of the porous metal layer 270 may be a minimum injection amount for a normal operation of the heat pipe liner 200.

The amount of the working fluid injected in the excess of the amount of the working fluid injected corresponding to the pores of the porous metal layer 270 may mean the minimum amount required to form a liquid layer in the condensation section inside the heat pipe liner 200.

The heat pipe liner 200 may be formed with an injection port 231 capable of injecting the working fluid into the internal space 250 of the heat pipe liner 200, and a degassing port 233 capable of discharging a residual gas (e.g., an air, and the like) in the internal space 250 to the outside.

The working fluid (e.g., an alkali metal in a liquid) may be injected into the internal space 250 through the injection port 231. The remaining gas remaining in the internal space 250 may be discharged to the outside through the degassing port 233.

In an embodiment of the present disclosure, the injection port 231 and the degassing port 233 formed in the heat pipe liner 200 are described as being formed as separate ports. The injection port 231 and the degassing port 233 may be integrated and formed as a single port.

When the injection port 231 and the degassing port 233 are integrated into one single port, after the working fluid may be injected into the internal space 250 through the single port, the remaining gas remaining in the internal space 250 may be discharged to the outside through the single port.

Hereinafter, a hydrogen generator including a heat pipe liner according to an embodiment of the present disclosure is described in detail with reference to attached drawings.

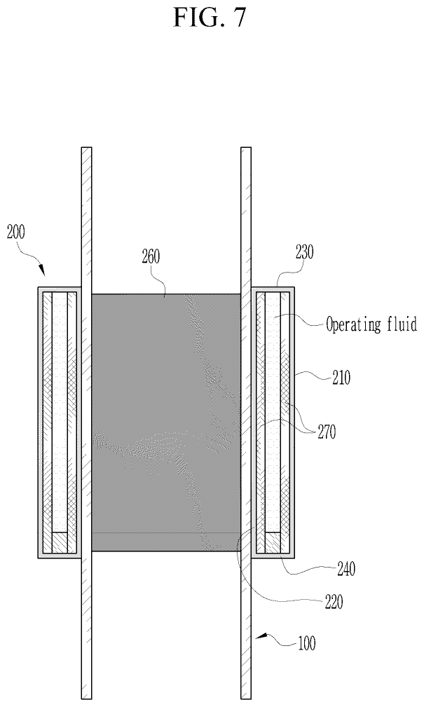

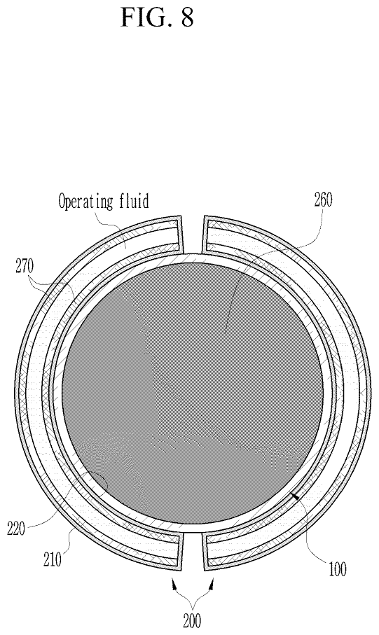

FIG. 7 is a conceptual view illustrating a side cross-section of a hydrogen generator according to an embodiment of the present disclosure. FIG. 8 is a view conceptually illustrating a planar cross-section of a hydrogen generator according to an embodiment of the present disclosure. Hereinafter, the differences from the described hydrogen generator are described in detail with reference to FIGS. 1-6.

Referring to FIG. 7 and FIG. 8, a hydrogen generator including a heat pipe according to an embodiment of the present disclosure may include a reforming reactor 100 and a heat pipe liner 200.

The reforming reactor 100 may produce a product including hydrogen through a chemical reaction (a catalytic reaction) with a reactant. The reforming reactor 100 may be formed into a cylinder shape with an empty interior.

The heat pipe liner 200 may maintain the temperature of the reforming reactor 100 to be uniform by the catalytic reaction in the reforming reactor 100, and the heat pipe liner 200 may be provided on the outside of the reforming reactor 100. For example, the heat pipe liner 200 may be arranged surrounding the exterior of the reforming reactor 100.

Referring to FIGS. 1-6, the heat pipe liner may be formed of the same shape as the described heat pipe liner 200. However, the interior diameter of the internal tube 220 of the heat pipe liner 200 of FIG. 7 and FIG. 8 may be larger than the exterior diameter of the reforming reactor 100.

The heat pipe liner 200 may be provided in a pair facing each other, and the pair of heat pipe liner 200 may be arranged to surround the reforming reactor 100. In this way, when the pair of heat pipe liners 200 are arranged to surround the reforming reactor 100 while facing each other, it becomes easy to install the heat pipe liner 200 on the outside of the reforming reactor 100, and it may have the advantage of convenient maintenance.

The external tube 210 may be formed in an arc shape, and the internal tube 220 may be formed in an arc shape with a diameter smaller than that of the external tube 210. The internal tube 220 may be combined with the external tube 210 to form an internal space 250.

The upper plate 230 may be formed in a ring shape of a circular plate with an opening in the approximate center, and cover the upper portion of the internal space 250 formed between the external tube 210 and the internal tube 220.

The lower plate 240 may be formed in a ring shape with an opening in the approximate center and cover the lower portion of the internal space 250 formed between the external tube 210 and the internal tube 220.

The materials of the external tube 210, the internal tube 220, the upper plate 230, and the lower plate 240 of the heat pipe liner 200 are as described above, and are not described in further detail.

The structure and the material of the porous metal layer 270 formed in the internal space 250 of the heat pipe liner 200 are as described above, and are not described in further detail.

Also, the working fluid injected into the internal space 250 of the heat pipe liner 200 is also as described above, and is not described in further detail.

In the hydrogen generator illustrated in FIG. 7 and FIG. 8, the catalyst bed 260 may be provided inside the reforming reactor 100. Therefore, the uneven temperature change in the reforming reactor 100 due to the catalytic reaction in the catalyst bed 260 may be improved by the heat pipe liner.

Hereinafter, the operation of the hydrogen generator according to an embodiment of the present disclosure is described in detail.

When the reactant is injected into the reforming reactor 100 and a chemical reaction (e.g., a catalytic reaction) occurs between the catalyst of the catalyst bed 260 and the injected reactant, a product including hydrogen and carbon monoxide may be generated.

A high temperature part having a relatively high temperature and a low temperature part having a relatively low temperature may be formed in the catalyst bed 260 of the reforming reactor 100 due to the endothermic reaction of the catalytic reaction.

The heat pipe liner 200, which is arranged to surround the reforming reactor 100 at the inside or the outside, may be formed with an evaporation part that absorbs heat from the high temperature part of the reforming reactor 100 and evaporates the working fluid, an insulation part in which the gaseous working fluid flows at high speed, and a condensation part in which the heat of the working fluid is released and the working fluid is condensed.

The evaporation part may be formed in the heat pipe liner 200 adjacent to the high temperature part of the reforming reactor 100. The insulation part may be formed in the central portion of the heat pipe liner 200. The condensation part may be formed on the heat pipe liner 200 adjacent to the low temperature part of the reforming reactor 100.

The heat pipe liner 200 transports heat of the reforming reactor 100 from the high temperature part to the low temperature part by the continuous flow of the working fluid involving a phase change (the evaporation and the condensation), thereby improving the temperature gradient of the reforming reactor 100.

The driving torque that generates this continuous flow of the working fluid may include a driving torque (a driving torque due to high-speed convection of the working fluid in a gaseous state) due to the difference in the saturated vapor pressure caused by the temperature difference between the evaporation part and the condensation part and a driving torque due to the capillary pressure difference occurring at the gas-liquid phase interface of the porous metal layer 270.

When being applied to an environment where there are local low temperature parts and high temperature parts, the heat pipe liner 200 may significantly improve the temperature uniformity of the heat transport direction through the working fluid by utilizing the principle that the working fluid flows continuously by the naturally occurring driving torque as described above.

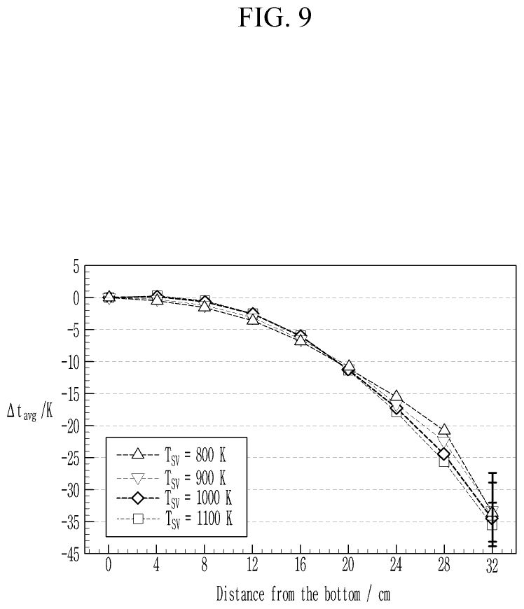

FIGS. 9-11 are views to explain the effect of a hydrogen generator according to an embodiment of the present disclosure. In the graphs of FIGS. 9-11, a horizontal axis represents the position from the bottom (e.g., the high temperature part) of the reforming reactor 100 and a vertical axis represents the difference in an average temperature measured at the position of the reforming reactor 100.

FIG. 9 is the graph showing the temperature measurement of the catalyst bed 260 of the reforming reactor 100 without the heat pipe liner 200 applied to the reforming reactor 100.

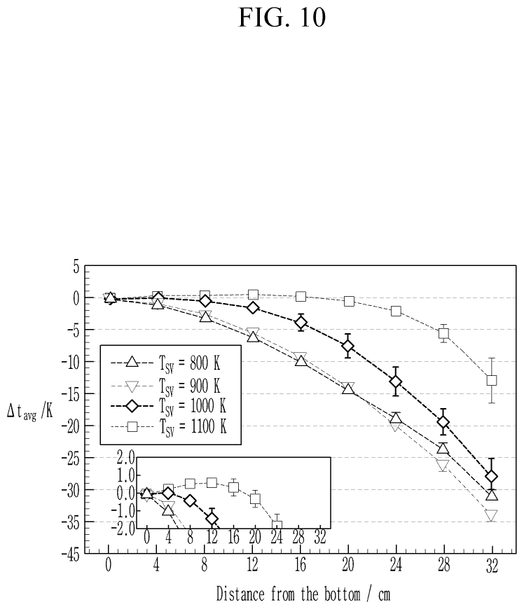

FIG. 10 is the graph showing the temperature of the catalyst bed 260 of the reforming reactor 100 measured when the heat pipe liner 200 is applied to the reforming reactor 100 and the amount of the working fluid injected is 5% or more than the volume of the pores of the porous metal layer 270.

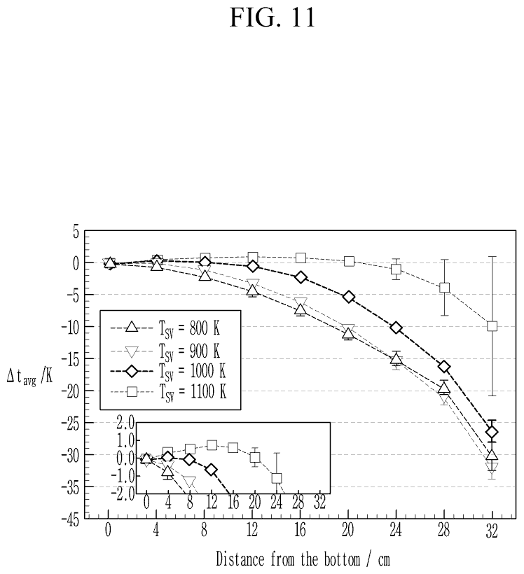

FIG. 11 is the graph showing the temperature of the catalyst bed 260 of the reforming reactor 100 measured when the heat pipe liner 200 is applied to the reforming reactor 100 and the amount of the working fluid injected is 10% or more than the volume of the pores of the porous metal layer 270.

In the graphs of FIGS. 9-11, the graph marked with a triangle is the graph when the test temperature is 800 K (approximately 530 degrees Celsius), the graph indicated by an inverted triangle is the graph when the test temperature is 900 K (approximately 630 degrees Celsius), the graph marked with a circle is the graph when the test temperature is 1,000 K (approximately 730 degrees Celsius), the graph marked with a quadrangle is the graph when the test temperature is 1,100 K (approximately 830 degrees Celsius).

The test temperature may be the temperature at which the heat pipe liner 200 is heated to evaluate the performance of the heat pipe liner 200.

Referring to FIG. 9, when the heat pipe liner 200 was not applied, it may be confirmed that the temperature of the reforming reactor 100 monotonically decreased with the increase of the temperature measurement position at all test temperatures, and when the test temperature was approximately 1,100 K (approximately 830 degrees Celsius), the temperature difference reached approximately 11 degrees Celsius.

Referring to FIGS. 10-11, when the heat pipe liner 200 was applied, it may be confirmed that the flow of the working fluid started at the test temperature of 1000 K (approximately 730 degrees Celsius) or higher, and the temperature uniformity of the reforming reactor (100, catalyst bed 260) was improved. When the test temperature is 1,100 K (approximately 830 degrees Celsius), the temperature difference at the 20 cm position may be less than +0.5 degrees Celsius.

Through these experimental results, it may be confirmed that when the heat pipe liner 200 is applied to the reforming reactor 100, the uniformity of the internal temperature of the reforming reactor 100 is improved.

In an embodiment of the present disclosure, when an imbalanced temperature field is formed in the reforming reactor 100 by an endothermic reaction within the catalyst bed 260, a rapid thermal diffusion may occur from the high temperature part to the low temperature part of the reforming reactor 100 due to the high-speed heat transfer function of the working fluid of the heat pipe liner 200, thereby improving the temperature uniformity of the reforming reactor 100 (the temperature uniformity within the catalyst bed 260).

These functions of the heat pipe liner 200 may be implemented by the continuous flow of the working fluid, which uses a saturated vapor pressure difference and a capillary pressure difference naturally generated by the small amount of the working fluid injected into the closed and sealed internal space 250 and the porous metal layer 270 (e.g., a wick) having a micropore structure as the driving torque.

While this disclosure has been described in connection with what is presently considered to be practical embodiments of the present disclosure, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: reforming reactor
200: heat pipe liner
210: external tube
220: internal tube
230: upper plate
231: injection port
233: degassing port
240: lower plate
250: internal space
260: catalyst bed
270: porous metal layer

What is claimed is:

1. A hydrogen generator comprising:
a reforming reactor configured to produce hydrogen by a catalytic reaction of a reactant; and
a heat pipe liner configured to maintain a temperature of the reforming reactor uniformly, the heat pipe liner provided inside the reforming reactor,
wherein the heat pipe liner includes:
an external tube with a hollow interior;
an internal tube provided inside the external tube, wherein an internal space is formed between the external tube and the internal tube;
an upper plate covering an upper part of the internal space;
a lower plate covering a lower part of the internal space;
a catalyst bed where a chemical reaction with the reactant inside the internal tube occurs; and
a porous metal layer formed in the internal space, wherein a working fluid circulates through pores of the porous metal layer.

2. The hydrogen generator of claim 1, wherein:
the external tube and the internal tube are formed into a cylinder shape with an empty interior, and
the external tube and the internal tube are arranged concentrically.

3. The hydrogen generator of claim 1, further comprising:
an injection port formed in the upper plate and the lower plate, wherein the working fluid is injected into the internal space through the injection port; and
a degassing port formed in the upper plate and the lower plate, wherein a residual gas in the internal space is discharged through the degassing port.

4. The hydrogen generator of claim 3, wherein the injection port and the degassing port are implemented as separate ports, or integrated into a single port.

5. The hydrogen generator of claim 1, wherein the porous metal layer is formed by sintering and attaching a metal powder to a predetermined thickness on an inner surface of the external tube and an exterior surface of the internal tube.

6. The hydrogen generator of claim 5, wherein the pores formed in the porous metal layer are formed to be fluidly connected to each other.

7. The hydrogen generator of claim 6, wherein the pores formed in the porous metal layer have a predetermined size to generate a capillary pressure difference in the working fluid.

8. The hydrogen generator of claim 1, wherein the working fluid is an alkali metal.

9. The hydrogen generator of claim 8, wherein the working fluid is sodium, potassium, a eutectic alloy of sodium and potassium, or any combination thereof.

10. The hydrogen generator of claim 1, wherein a volume of the working fluid injected into the internal space is greater than a volume of the pores of the porous metal layer by a predetermined amount.

11. A hydrogen generator comprising:
a reforming reactor configured to produce hydrogen by a catalytic reaction of a reactant; and
a heat pipe liner configured to maintain a temperature of the reforming reactor, the heat pipe liner provided inside the reforming reactor,
wherein the heat pipe liner includes:
an external tube with a hollow interior;
an internal tube provided inside the external tube, wherein an internal space is formed between the external tube and the internal tube;
an upper plate covering an upper part of the internal space;
a lower plate covering a lower part of the internal space;
a catalyst layer where a chemical reaction with the reactant inside the reforming reactor occurs; and
a porous metal layer formed in the internal space, wherein a working fluid circulates through pores of the porous metal layer.

12. The hydrogen generator of claim 11, wherein:
the external tube and the internal tube are formed into a cylinder shape with an empty interior, and
the external tube and the internal tube are arranged concentrically.

13. The hydrogen generator of claim 11, further comprising:
an injection port formed in the upper plate and the lower plate, wherein the working fluid is injected into the internal space through the injection port; and
a degassing port formed in the upper plate and the lower plate, wherein a residual gas in the internal space is discharged through the degassing port.

14. The hydrogen generator of claim 13, wherein the injection port and the degassing port are implemented as separate ports or integrated into a single port.

15. The hydrogen generator of claim 11, wherein the porous metal layer is formed by sintering and attaching a metal powder to a predetermined thickness on an inner surface of the external tube and an exterior surface of the internal tube.

16. The hydrogen generator of claim 15, wherein the pores formed in the porous metal layer are formed to be fluidly connected to each other.

17. The hydrogen generator of claim 16, wherein the pores formed in the porous metal layer have a predetermined size to generate a capillary pressure difference.

18. The hydrogen generator of claim 11, wherein the working fluid is an alkali metal.

19. The hydrogen generator of claim 17, wherein the working fluid is sodium, potassium, a eutectic alloy of sodium and potassium, or a combination thereof.

20. The hydrogen generator of claim 11, wherein a volume of working fluid injected into the internal space is greater than a volume of the pores of the porous metal layer by a predetermined amount.
